(19) United States
(12) Patent Application Publication
(10) Pub. No.: US 2014/0279061 A1
(43) Pub. Date: Sep. 18, 2014

(54) Social Media Branding

(71) Applicant: Rapp Worldwide Inc., New York, NY (US)

(72) Inventors: Craig Allen Elimeliah, New York, NY (US); Juan Camilo La Cruz-Smith, Brooklyn, NY (US)

(73) Assignee: Rapp Worldwide Inc., New York, NY (US)

(21) Appl. No.: 13/841,486

(22) Filed: Mar. 15, 2013

(51) Int. Cl. G06Q 50/00; G06Q 30/02

(52) U.S. Cl. CPC G06Q 50/01; G06Q 30/0276
USPC 705/14.72

(57) ABSTRACT

Methods, systems and computer-readable storage mediums encoded with computer programs executed by one or more processors for providing social media branding are disclosed. A brand strategy construct including a markup tag, a destination platform, a media-type, and a media filter associated with the media-type is received. Posts to a social media platform (SMP) are monitored for media of the media-type associated with the markup tag. Media is extracted from the SMP upon a detection of media of the media-type associated with the markup tag in a post to the SMP. The media filter is applied to the extracted media to generate branded media. The branded media is provided to the destination platform.

### CROSS-REFERENCE TO RELATED APPLICATIONS

This application is related to co-pending application titled “Social Media Purchase Offers,” (U.S. application Ser. No. ______ to be assigned, Atty Docket Number 3349.0010000, filed Mar. 15, 2013), which is hereby incorporated by reference.

### FIELD

Embodiments herein relate generally to social media branding.

### BACKGROUND

Social media is a growing focus for companies and other organizations that are trying develop, expand, or define a brand for a product, service, or feature. Using social media, companies are able to interact with customers or potential customers on a more personal level than may be done through traditional advertising. From an end user point of view, social media allows users to converse with other users about any topics found mutually interesting or noteworthy.

Many companies try to interact directly with the people who are connected to them through a social media platform (SMP) and become part of the conversations being had by users, particularly when those users are conversing about the company or its products. However, tracking social media posts about the company could become a labor-intensive task as millions of SMP users have conversations about the company or its products.

### BRIEF SUMMARY

An embodiment of the invention as described in this specification may include a method. A brand strategy including a markup tag, a destination platform, a media-type, and a media filter associated with the media-type is received. Posts to a social media platform (SMP) are monitored for media of the media-type associated with the markup tag. Media is extracted from the SMP upon a detection of media of the media-type associated with the markup tag in a post to the SMP. The media filter is applied to the extracted media to generate branded media. The branded media is provided to the destination platform.

Other embodiments of this aspect include corresponding systems, apparatus, and computer programs, configured to perform the actions of the methods, encoded on computer storage devices. Further embodiments, features, and advantages, as well as the structure and operation of the various embodiments, are described in detail below with reference to accompanying drawings.

### BRIEF DESCRIPTION OF THE FIGURES

Embodiment are described with reference to the accompanying drawings, in the drawings, like reference numbers may indicate identical or functionally similar elements. The drawing in which an element first appears is generally indicated by the left-most digit in the corresponding reference number.

FIG. 1 is a hock diagram illustrating a system for social media branding, according to an example embodiment.

FIG. 2 is a flow chart of a process of a system for social media branding, according to an example embodiment.

FIG. 3 is a system diagram that can be used to embody or implement embodiments described herein.

### DETAILED DESCRIPTION

While the present disclosure makes reference to illustrative embodiments for particular applications, it should be understood that embodiments are not limited thereto. Other embodiments are possible, and modifications can be made to the embodiments within the spirit and scope of the teachings herein, and additional fields in which the embodiments would be of significant utility. Further, when a particular feature, structure, or characteristic is described in connection with an embodiment, it is submitted that it is within the knowledge of one skilled in the relevant art to affect such feature, structure, or characteristic in connection with other embodiments whether or not explicitly described.

The owner or sponsor of a product, line of products, or brand may want to utilize or repurpose user-generated content to brand or promote its own products. It may be particularly useful if such repurposing or branding may occur in real-time or near real-time, especially if the user-generated content is provided about an ongoing event or conversation. For example, an owner of a football team may desire to promote the football team by placing the logo of the football team on images (e.g., content) posted on a social media platform about an ongoing game it which the football team is playing. Other examples, may include less time sensitive uses, such as posted multimedia about a product or service.

The ability to identity, capture, and repurpose user-generated content and available user data in real-time may have marketing advantages for the sponsor. For example, it may allow the sponsor of a product to keep customers or potential customers interested in the brand, by interacting with such users in real-time, while the users have shown interest in the brand, event, or other topic of discussion.

FIG. 1 is a block diagram illustrating a system 100 for social media branding, according to an example embodiment. In system 100, a media branding system (MBS) 102 may monitor and brand social media posts 108 to a social media platform (SMP) 106 based on a brand strategy construct (hereinafter, “brand strategy”) 104. SMP 106 may be any social media platform, such as, for example and without limitation, Twitter®, Pinterest®, Facebook®, LinkedIn®, etc.

Brand strategy 104 may include selections of how a sponsor 105 desires to brand or market a product 107 using social media, or more particularly a social media platform (SMP) 106. Sponsor 105 may be an individual, company, or other entity that is involved with the promotion, marketing, advertising, or branding (hereinafter collectively referred to as “branding”) of product 107. Sponsor 105 may for example, include an owner, manufacturer, or distributor of product 107.

Product 107 may be any item or product, product line, brand, service, entity (including sponsor 105), or other marketable feature to be branded by sponsor 105 through social media based on brand strategy 104. For example, a shoe company (sponsor 105) may develop a marketing strategy for marketing a new line of sneakers (product 107), or a political campaign (sponsor 105) may seek to brand a politician, political party, or particular issue (product 107). Or, for example, a municipality (sponsor 105) may seek to brand itself (product 107) to increase tourism or otherwise attract people.

Brand strategy 104 may include any decisions or strategies regarding what issues or social media posts 108 are relevant to branding product 107. Brand strategy 104 may, for example, be part of an overall marketing strategy for branding product 107, which may include other traditional types of advertising. Brand strategy 104 may include various options or selections, as will be discussed in greater detail below, that may be made by sponsor 105 for branding product 107 through or using one or more SMPs 106.

MBS 102 may monitor SMP 106 for posts 108 relevant to product 107 as defined in accordance with brand strategy 104. A monitor 130 may monitor SMP 106 for posts 108 that are identified within brand strategy 104 as being relevant to product 107. Upon detection of a relevant post 108 by monitor 130, an extractor 132 may extract content or media 109 of the post 108. A brander 134 may then brand, filter, or otherwise repurpose the extracted content or media 109 and available user info 124 from SMP 106 and otherwise available user data, as branded media 111 based on a media-type 116, media filter 118, and an indicator 120 of brand strategy 104. Brander 134 may then aggregate or post branded media 111 to a destination platform 110 in accordance with destination 122 of brand strategy 104. MBS 102 may allow sponsor 105 of product 107 to repurpose social-media posts 108 available through SMP 106 in real-time and without user intervention.

SMP 106 may include any platform that allows users to communicate or interact with each other or the public through posts 108 or uploads of media 109 to the SMP 106. SMP 106 may be, for example, a website or service that allows users to contribute media 109 via posts 108. Media 109 may include text, images, video, or other multimedia. SMP 106 may allow users to register with SMP 106 to post media 109 to SMP, and allow other users or the public to view or use posts 108. For example, a registered user may take an image (media 109) with a cell phone camera and provide or post the image to SMP 106 as post 108 for other users to see or access. In addition to posting the picture, the user may also be able to provide text or a description that describes or categorizes the picture. The combination of text and image, or the image alone, may constitute media 109 as used in various embodiments.

As referenced above, sponsor 105 may be any entity seeking to brand product 107. In the example provided above, sponsor 105 may be a shoe company desiring to launch a new line of sneakers (product 107). However it is understood that such an embodiment is exemplary only, and that system 100 may be used in numerous other circumstances with different types of sponsors 105 and products 107 as well. For example, sponsor 105 may be a news organization seeking to encourage and accumulate posts about a particular news story (product 107) which may be ongoing, an accounting company that desires to brand a new tax service (product 107), a computer company that desires to brand an existing software or a feature of a particular product (product 107), an author desiring to accumulate posts about a recently published book or article (product 107), an owner of a retail store (product 107) that desires to bring attention to the opening of the store, the products sold, or an ongoing or future promotion, or a candidate for public office (sponsor 105) desiring to brand himself/herself or a particular issue or geographical area (product 107).

In an embodiment, brand strategy 104 for product 107 may be specified or varied based on geographical location. For example, sponsor 105 may desire to implement a first brand strategy 104 in location 1 (e.g., which may be defined by a central point and surrounding radius) and a second brand strategy 104 in location 2 (e.g., which may be the name of a state, city, or other geographical description). Then, for example, in an embodiment, if the location of a user who provides post 108 to SMP 106 is known, monitor 130 or brander 134 may compare the user location against any defined geographic locations of interest with regard to brand strategy 104.

Sponsor 105 may generate or provide information for brand strategy 104 that may include decisions on how to brand product 107 using SMP 106. MBS 102 may then implement brand strategy 104 on SMP 106, for example monitoring posts 108 to SMP 108 that include a markup tag 112 as provided in brand strategy 104.

Markup tag 112 may be a social media marker, keyword, or text used to identify, categorize, or otherwise describe post 108 on SMP 106, such as, for example, a hashtag. Markup tag 112 may be used by users of SMP 106, for example, to convey a context of media 109 or so that post 108 may be more easily searched for or identified on SMP 106. For example, markup tag 112 may be included with or otherwise associated with post 108 to indicate the subject matter, event, or category of post 108. Markup tag 112 may be used, for example, to describe a known location or event, such as “#NYC” or “#ThanksgivingParade.”

In an embodiment, markup tag 112 may include a designated symbolic character portion (char) 112A and an alphanumeric tag description portion (tag) 112B. Char 112A may be a symbol or other character that indicates that a markup tag is present. For example, as is commonly known, char 112A may be a hash “#” symbol. In additional embodiments, char 112A may be a dollar sign “$”, percent “%”, caret “̂”, asterisk “*”, ampersand (“&”) or other symbol, or combination of symbols. In an embodiment, each different char 112A used in markup tag 112 is be associated with a different intent of what information is being conveyed by tag 112B with regard to post 108.

Tag 112B may be a description of whatever information a user of SMP 106 intends to convey with post 108 in the context of char 112A. Char 112A “#” may be a general indicator for a categorization or description of tag 112B. In an embodiment, tag 112B may be a well-known designation used to describe media 109 of post 108. For example, a user may post a picture (media 109) taken at a sports event with markup tag 112 “#FightingEagles,” in which “Fighting Eagles” is the name of one of the competing sports teams and is used as tag 112B. Or, for example, a user may post a video (media 109) from a newsworthy event or story, such as a court case, election, or natural disaster, with a markup tag 112 “#PresidentialElection,” for an election. In an embodiment, there are no space characters separating char 112A from tag 112B in markup tag 112. Tag 112B may be whatever searchable alphanumeric or symbolic description a user desires to associate with post 108.

Monitor 130 may use markup tag 112, as provided within the context of brand strategy 104, to identify posts 108 to SMP 106 relevant to the branding of product 107. Brand strategy 104 may specify both char 112A and tag 112B that are relevant to the branding of product 107. For example, a shoe company may be launching a new sneaker line called “Super Sneaker,” and via brand strategy 104 may provide markup tag 112 “#SuperSneaker” and/or “#SuperShoe.”

Platform 114 may indicate to which SMP(s) 106 to direct brand strategy 104. For example, there may be available various SMPs 106 directed to different social media purposes. For example, a first SMP 106 may be directed to allowing users to develop business connections, while another may primarily feature social interactions. Platform 114 may indicate to which SMP(s) brand strategy 104 is to be directed.

In an embodiment, each SMP 106 may have its own unique markup tag 112 format. For example, markup tag 112 for a first SMP 106 may include char 112A, while markup tag 112 for another SMP 106 may not include a first char 112A, and may only include tag 112B or may include a different char 112A. In an embodiment, if multiple SMPs 106 are designated with platform 114, then each SMP 106 may have its own markup tag 112 designation(s).

Media-type 116 is an indication as to which type of media 109 is to be extracted from post 108. Media 109 may include any type or combination of media that may be included in posts 108. Different SMPs 106 may allow users to post varying combinations or types of media 109. For example, a first SMP 106 may only allow text posts 108 with a maximum character length, while another SMP 106 may allow users to post any type of media 109.

Media 109 may include images, video, text, or other multimedia. Correspondingly, media-type 116 may include any selection of a type, combination of types, or limitations on types of media 109 relevant to branding product 107. For example, media-type 116 may specify images (e.g., still images), panoramic images, video, video or images less than a particular file size or greater than a particular file size, text, text and images, text having fewer than a specified number of characters, or media of specified file format.

As referenced above, monitor 130 may perform real-time monitoring, scanning, and/or parsing of SMP 106 for posts 108 including markup tag 112 and media 109 of media-type 116 in accordance with brand strategy 104. For example, monitor 130 may monitor SMP 106 for posts 108 that include markup tag 112 “#SuperShoe” in accordance with brand strategy 104.

Monitor 130 may further filter or sort what type of posts 108 are monitored or detected on by media-type 116. For example, brand strategy 104 may designate media type 116 as still images with a file size greater than 10 MB and less than 50 MB. Then for example, upon detection of post 108 with markup tag 112 “#SuperShoe,” monitor 130 may further determine whether the post 108 includes still image media 109, and whether the still image media has a file size greater than TOMB and less than 50 MB. In an embodiment, monitor 130 may be able to access or monitor posts 108 on SMP 106 using an application programming interface (API) for SMP 106.

After a detection of one or more posts 108 matching markup tag 112 and media-type 116 by monitor 130 extractor 132 ma extract or request media 109 and user info 124 associated with post 108 from SMP 106. User info 124 may include any user information collected by SMP 106 as provided by or about a user who posts 108 to SMP 106 and made available or accessible to MBS 102. User info 124 may include, for example, name, username, location, age, connections (e.g., to other users), previous posts or user activity information, a device-used, phone number, or other information. In an embodiment, a user may need to consent for SNIP 106 to release this information, a subset thereof; or other information to NIBS 102.

In an embodiment, MBS 102 may not only use user info 124 available from SMP 106, but may also user other data that may be otherwise available. For example, if user info 124 provides a name of a user, MBS 102 may automatically perform a web search for the name of the user as provided with user info 124, and use information regarding the user in branded media 111. In another example embodiment, if post 108 is related to the occurrence of a particular event, MBS 102 may combine content of post 108, user info 124 and publicly available information about the particular event to generate branded media 111.

Brand strategy 104 may include additional limitations on monitoring posts 108 from users with particular user info 124 settings. For example, brand strategy 104 may include an indication to only extract posts 108 from users with more than 100 connections to other users of SMP 106. Using the SMP API, extractor 132 may extract, request, or otherwise access media 109 and other content of post 108 and user info 124 that may be made available by SMP 106.

Media filter 118 is an indication of what type of additional processing, if any, is to be done with regards to media 109, posts 108, or user info 124 extracted from SMP 106. Media filter 118 may include any type of processing or adjustments that may be done to media 109, and may vary or be based on media-type 116. For example, if media-type 116 is still image, media filter 118 may include sharpening the image, converting the image to black and white, adjusting contrast, brightness, or hue, applying a color filter, adding text, or other image processing. If media-type 116 is text, then media filter 118 may include scanning and removing particular words or phrases, inserting text, bolding, highlighting, coloring text, spell checking, or performing any other text analysis, format, or adjustments. In an embodiment, sponsor 105 may create and provide its own specialized media filter 118, combination, or sequence of filters to be used on one or more media-types 116.

Indicator 120 may include a brand indicator that is appended or otherwise applied to extracted media 109 as part of, prior to, or subsequent to applying media filter(s) 118. Indicator 120 may include an image, text, video, or other media to be appended to, overlaid with, or otherwise combined with media 109. Indicator 120 may be a brand indictor that indicates, references, represents, or signifies product 107 and/or sponsor 105. For example, indicator 120 may be a company logo, name, or trademark to be applied to all images extracted from SMP 106. Or, for example, indicator 120 may be a short video or commercial that is appended to the beginning or ending of all extracted videos.

Brander 134 may brand the extracted media 109 based on media filter 118 and/or indicator 120 of brand strategy 104. Brander 134 may, for example, apply indicator 120 to extracted media 109, and apply one or more selected or provided media filters 118. Brander 134 may, for example, alter or adjust settings on media 109 as specified by media filter 118, apply indicator 120, and save the filtered and indicator 120 applied media 109 as branded media 111. For example, brander 134 may apply a logo (indicator 120) to a photograph (media 109) of an event (product 107). Brander 134 may apply indicator 120 and media filter 118 in whichever order may be specified by brand strategy 104, or using a default order, which, for example, may be to apply media filter 118 and then apply indicator 120. Brander 134 may generate branded media 111 as a result of applying media filter 118 and indicator 120.

In an embodiment, different chars 112A may allow users of SMP 106 to convey a different intent for markup tag 112 of posts 108, including modifying or editing the posted media 108. For example, while a hash sign (“#”) may allow a user to describe or categorize post 108, an ampersand (“&”) may indicate an intent to edit media 109. In an embodiment, “&” may indicate an intent by user to overlay text of tag 112B on media 109. For example, a user may take a picture of a meal ordered in a restaurant. The user may then upload the picture (media 109) to SMP 106 with a markup tag 112 that reads “&BestPizzaEver!” Monitor 130 102 may identify the “&” char 112A as an intent to overlay the picture with the provided tag 112B. Brander 134 may then perform the overlay function with tag 112B, and generate a new picture (e.g., branded media 111) of the meal with the overlaid text “Best Pizza Ever!” In an example, the new picture with overlaid text is an in the form of a meme.

In a further embodiment, the user may use multiple markup tags 112 with different chars 112A, or combine chars 112A into a single markup tag 112. For example post 108 may include markup tags 112 “&BestPizzaEver!” “#RomanosPizza,” Or, for example, post 108 may include markup tag 112 “#&GoToRomanosPizza.” Monitor 130 may then recognize the markup tag 112 as both a categorization and instruction to overlay text “Go To Romanos Pizza” on media 109.

Brander 134 may provide branded media 111 to destination platform 110 in accordance with destination 122 as specified in brand strategy 104. Destination 122 may provide any requirements or specifications as to how, where, or when branded media 111 is to be provided or posted. For example, destination 122 may indicate that branded media 111 is to be posted directly back to SMP 106. Or, for example, destination 122 may indicate that branded media 111 is to be posted to a website, another SMP 106, or other location(s). In an embodiment, destination 122 may indicate that branded media 111 then be sent back to the original poster as a result of the “&” use. Destination 122 may indicate that branded media 111 is to be provided in real-time, with a particular time delay, or only upon approval by a human operator who may scan branded media 111 for inappropriate or undesirable content.

In an embodiment, brander 134 may provide a link or access to branded media 111 to the user who posted media 109. User may then have access to branded media 111 prior or after posting to destination platform 110. Destination platform 110 may be any platform capable of or otherwise suited for displaying branded media 111, including, for example, a SMP 106, website, blog, database, or other service or medium.

MBS 102 may include a trend engine 136. Trend engine 136 may aggregate, process, and/or analyze all data accessible to MBS 102, including user info 124, posts 108, interactions with destination platform 110, and otherwise available data to determine trends or patterns within the data. Trend engine 136 may allow for non-linear tracking, monitoring, and/or reporting of information.

Based on posts 108 detected as being, relevant to product 107 as determined by monitor 130 based on brand strategy 104, trend engine 136 may determine relationships between the posts 108, user info 124, or other data. For example, trend engine 136 may determine that during the occurrence of a particular event defined by markup tag 112, what percentage or number of posts 108 included media 109 of a particular media-type 116 (e.g., what percentage or number of posts were still images, or were text only).

Or, for example, trend engine 136 may determine trends of posts during a football game (product 107). Trend engine 136 may determine, for example, that 65% of posts about a first subject were about sponsor 105, and the remaining 35% of posts were about sponsor's 105 competitors. Or, for example, trend engine 136 may determine that 80% of men who posted with markup tag 112 posted images of product 107, while only 30% of women who posted with markup tag 112 posted images of product 107, and the remaining 70% posted about other subjects. In an embodiment, sponsor 105, through brand strategy 104, may specify particular trends desired to be monitored or detected by trend engine 136. Or, for example, trend engine 136 may include learning logic where it is able to determine trends in subject matter and user information based on whatever posts 108 are monitored by monitor 130. Trend engine 136 may be identify or filter trends based on any available factors or parameters, such as with a time period, during the occurrence of an event, within a geographic region, based on the sex of the user, media-type 116, or other available parameter(s).

In an embodiment, identified trends by trend engine 136 may be used to determine destination platform 110. For example, if trend engine 136 determines that the majority of posts 108 relevant to brand strategy 104 include text-only media 109, destination platform 1110 may include a text-based blog. Or, for example, if trend engine 136 determines that more than a defined percentage of posts 108 include image media 109, destination platform 110 may include a photo album or webpage.

Though not specifically shown in system 100, it is understood that any data, including trend information, may be stored on a database or other system for later use, analysis or reporting. For example, trends detected during a first election process may be compared against trend detected during a second election process that may occur four years later.

MBS 102 may allow sponsor 105 to customize how social media is to be used to brand, market, or promote product 107. Based on brand strategy 104, MBS 102 may, in real-time and without user intervention, monitor SMPs 106 for posts 108 of interest to sponsor 105. MBS 102 may further extract and repurpose available media 109 from SMP 106 as branded media 111, and repost or reuse branded media 111 in any manner consistent with brand strategy 104. In an embodiment, MBS 102 may be used to monitor multiple SMPs 106 for different sponsors 105, each of which may have one or more brand strategies 104 for any number of brands or products 107.

FIG. 2 is a flowchart of a process 200 for social media branding according to an example embodiment. The stages of FIG. 2 are described below, in, non-limiting examples, with reference to FIG. 1.

At stage 210, a hand strategy is received. For example, MBS 102 may receive brand strategy 104. Brand strategy 104 may be, for example, a portion of a marketing strategy for a new product line or service that sponsor 105 desires to, promote. Sponsor 105 may provide various preferences or values on which markup tag(s) 112 and media-type(s) 116 sponsor 105 desires to repurpose for promoting the new product line. Sponsor 105 may further specify which platform 114 (i.e., SMP 106) should be monitored for markup tag 112, which media-type 116 is to be extracted, and how the extracted media 109 should be filtered with media filter 118.

At stage 220, posts to a social-media platform are monitored for media of a specified media-type associated with the markup tag. For example, monitor 130 may monitor posts 108 to SMP 106 from all or a subset of users 111 of SMP 106. Monitor 130 may, in real-time, or close to real-time, monitor posts 108 to SMP 106 from all the users or a subset of users of SMP 106, for posts 108 with a markup tag 112 that corresponds to markup tag 112 as specified by brand strategy 104. Upon detection of markup tag 112, monitor 130 may further determine whether posts 108 have media 109 of the specified media-type 116 of brand strategy 104.

At stage 230, media is extracted from SMP 106. For example, extractor 112 may extract media 109 of media-type 116 from post 108. In an embodiment, post 108 may include media 109 of varying media-types 116 (e.g., text, images, and video). Extractor 132, using API for SMP 106, may then extract only media 109 that corresponds to the specified media-type of 116 of brand strategy 104. Extractor 132 may also extract or request user info 124 about which user provided or posted post 108 on SMP 106.

At stage 240, media filter is applied to the extracted media to generate branded media. For example, brander 134 may apply media filter 118 to extracted media 109. Brander 134 may automatically, without user involvement, adjust the settings of media 109 based on the specifications of media filter 118. Brander 134 may adjust different media-types 116 with different media filters 118. In an embodiment, text may have a text filter, images may have an image filer, and video may have a video filter. Brander 134 may further apply indicator 120 to the media 109 before or after filtering.

At stage 250, the branded media is provided to the destination platform. Brander 134 may provide branded media 134 to one or more destination platforms 110. For example, brander 134 may aggregate or organize branded media 111 as specified by destination 122 of brand strategy 104. In an embodiment, brander 134 may post branded media 111 to a website within moments of post 108 being posted to SMP 106. Brander 134 may, in an embodiment, organize branded media 111 by location, time, user, SMP 106, or any other criteria when posting or providing to destination platform 110.

FIG. 3 illustrates an example computer system 300 in which embodiments as described herein, or portions thereof, may be implemented as computer-readable code. For example, MBS 102, including portions thereof, may be implemented in computer system 300 using hardware, software, firmware, tangible computer readable media having instructions stored thereon, or a combination thereof, and may be implemented in one or more computer systems or other processing systems. Hardware, software, or any combination of such may embody any of the modules, procedures and components in FIGS. 1-2.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terms of this example computer system 300. After reading this description, it will become apparent to a person skilled in the relevant art how to implement the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 304 may be a single processor in a multi-core/multiprocessor system, such system may be operating alone, or in a cluster of computing devices operating in a cluster or server farm. Processor device 304 is connected to a communication infrastructure 306, for example, a bus, message queue, network, or multi-core message-passing scheme.

Computer system 300 also includes a main memory 308, for example, random access memory (RAM), and may also include a secondary memory 310. Main memory may include any kind of tangible memory. Secondary memory 310 may include, for example, a hard disk drive 312, removable storage drive 314. Removable storage drive 314 may comprise a floppy disk drive, a magnetic tape drive, an optical disk drive, a flash memory, or the like. The removable storage drive 314 reads from and/or writes to a removable storage unit 318 in a well-known manner. Removable storage unit 318 may include a floppy disk, magnetic tape, optical disk, etc. which is read by and written to by removable storage drive 314. As will be appreciated by persons skilled in the relevant art, removable storage unit 318 includes a computer readable storage medium having stored therein computer software and/or data.

Computer system 300 (optionally) includes a display interface 302 (which can include input and output devices such as keyboards, mice, etc.) that forwards graphics, text, and other data from communication infrastructure 306 (or from a frame buffer not shown) for display on display unit 329.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Communications interface 324 may include a modem, a network interface (such as an ethernet card), a communications port, a PCMCIA slot and card, or the like. Software and data transferred via communications interface 324 may be in the form of signals, which may be electronic, electromagnetic, optical, or other signals capable of being received by communications interface 324. These signals may be provided to communications interface 324 via a non-storage capable communications path 326. Communications path 526 carries signals and may be it using wire or cable, fiber optics, a phone line, a cellular phone link, an RF link or other communications channels.

In this document, the terms “computer storage medium” and “computer readable storage medium” are used to generally refer to media such as removable storage unit 318, removable storage unit 322, and a had disk installed in hard disk drive 312. Computer storage medium and computer readable storage medium may also refer to memories, such as main memory 308 and secondary memory 310, which may be memory semiconductors (e.g. DRAMs, etc).

Computer programs (also called computer control logic) are stored in main memory 308 and/or secondary memory 310. Computer programs may also be received via communications interface 324. Such computer programs, when executed, enable computer system 300 to implement embodiments as discussed herein. Where the embodiments are implemented using software, the software may be stored in a computer program product and loaded into computer system 300 using removable storage drive 314, interface 320, and hard disk drive 312, or communications interface 324.

Embodiments also may be directed to computer program products comprising software stored on any computer readable medium. Such software, when executed in one or more data processing device, causes a data processing device(s) to operate as described herein. Embodiments may employ any computer readable storage medium. Examples of computer readable storage mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It would also be apparent to one of skill in the relevant art that the embodiments, as described herein, can be implemented in many different embodiments of software, hardware, firmware, and/or the entities illustrated in the figures. Any actual, software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The Summary and Abstract sections may set forth one or more but not all exemplary embodiments as contemplated by the inventor(s), and thus, are not intended to limit the described embodiments or the appended claims in any way.

Various embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept as described herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described examples, but should be defined only in accordance with the following claims and their equivalents.

What is claimed is:

1. A system comprising:
a monitor configured to receive a brand strategy construct, the brand strategy construct including selections of: a markup tag, a destination, a media-type, and a media filter associated with the media-type;
the monitor, implemented on a processor, that when executed monitors a social media platform (SMP) for posts including media of the media-type that are associated with the markup tag, wherein the monitor is further configured to detect that media of the media-type associated with the markup tag is posted to the SMP;
an extractor configured to extract the detected media from the SMP; and
a brander configured to apply the media filter to the extracted media to generate branded media, and
wherein the brander is further configured to provide the branded media to the destination.

2. The system of claim 1, wherein the markup tag comprises a designated symbolic character indicating an intent of the markup tag and an alpha-numeric tag description associated with the designated symbolic character.

3. The system of claim 2, wherein the designated symbol character indicates an intent to superimpose the tag description on the media, and wherein the brander is further configured to superimpose the tag description on the media.

4. The system of claim 1, wherein:
the strategy evaluator is configured to receive a brand indicator associated with the brand strategy; and
the brander is configured to apply the brand indicator to the extracted media prior to the providing.

5. The system of claim 1, wherein the brander is further configured to:
determine which user is associated with the post based on user info from the SMP; and
provide, the user with the branded image.

6. A method comprising:
receiving a brand strategy construct, the brand strategy construct including selections of: a markup tag, a destination platform, a media-type, and a media filter associated with the media-type;
monitoring, by a processor, posts to a social media platform (SMP) for media of the media-type associated with the markup tag;
extracting the media from the SMP upon a detection of media of the media-type associated with the markup tag in a post to the SMP;
applying the media filter to the extracted media to generate branded media; and
providing the branded media to the destination platform.

7. The method of claim 6, wherein
the receiving comprises receiving a selection of one or more of a plurality of SMPs to be monitored, wherein each SMP is associated with one or more markup tags from the brand strategy; and
monitoring the selected one or more SMPs for posts associated with the corresponding one or more markup tags for each SMP.

8. The method of claim 6, wherein the markup tag comprises a designated symbolic character indicating an intent of the markup tag and an alpha-numeric tag description associated with the designated symbolic character.

9. The method of claim 9, wherein the designated symbol character comprises an ampersand.

10. The method of claim 9, wherein the designated symbol character indicates an intent to alter the media based on the tag description.

11. The method of claim 10, wherein the designated symbol character indicates an intent to superimpose the tag description on the media, and wherein the applying comprises superimposing the tag description on the media.

12. The method of claim 9, wherein the receiving comprises:
receiving a selection of a first markup tag, the first markup tag comprising a first designated symbol character; and
receiving a selection of a second markup tag, the second markup tag comprising a second designated symbolic character, wherein the second designated symbolic character is different from the first designated symbolic character and wherein each markup tag indicates a different intent.

13. The method of claim 6, further comprising:
extracting a plurality of media of the media-type and associated markup tag from the SMP, the plurality of media being provided by a plurality of users of the SMP;
applying the media filter to each of the extracted media; and
providing the plurality of filtered media to the destination.

14. The method of claim 6, further comprising:
receiving a brand indicator associated with the brand strategy; and
applying the brand indicator to the extracted media prior to the providing.

15. The method of claim 6, further comprising:
determining a user associated with the post from user info provided by the SMP;
providing the user with the branded image.

16. The method of claim 6, wherein the monitoring, extracting, applying, and providing are performed automatically in real-time, without user intervention.

17. A computer program product implemented on one or more processors and a tangible memory accessible to the one or more processors, the memory comprising code that when executed cause the one or more processors to:
receive a brand strategy construct, the brand strategy construct including selections of a markup tag, a destination, a media-type, and a media filter associated with the media-type;
monitor a social media platform (SMP) for posts including media of the media-type that are associated with the markup tag;
detect that media of the media-type associated with the markup tag is posted to the SMP;
extract the detected media from the SMP;
apply the media filter to the extracted media to generate branded media; and
provide the branded media to the destination.

18. The computer program product of claim 17, wherein the markup tag comprises a designated symbolic character indicating an intent of the markup tag and an alpha-numeric tag description associated with the designated symbolic character.

19. The computer program product of claim 18, wherein the designated symbol character indicates an intent to superimpose the tag description on the media and wherein the code when executed is further configured to superimpose the tag description on the media.

20. The computer program product of claim 18, wherein the code when executed is further configured to:
receive a brand indicator associated with the brand strategy constrict;
apply the brand indicator to the branded media prior to the providing; and
aggregate the branded media with additional branded media at the destination.
